(19) United States
(12) Patent Application Publication
(10) Pub. No.: US 2012/0090325 A1
(43) Pub. Date: Apr. 19, 2012

(54) ETHANOL PRODUCTION SYSTEM FOR ENHANCED OIL RECOVERY

(76) Inventor: Michael J. Lewis, Houston, TX (US)

(21) Appl. No.: 12/986,679

(22) Filed: Jan. 7, 2011

Related U.S. Application Data
(60) Provisional application No. 61/293,140, filed on Jan. 7, 2010.

(51) Int. Cl. F02C 6/00; E21B 43/16

(52) U.S. Cl. 60/772; 166/402

(57) ABSTRACT

A process for enhancing the energy output of an ethanol production facility has the steps of producing ethanol and stillage from a feedstock, anaerobically digesting said stillage so as to produce carbon dioxide and methane, compressing the methane, compressing the carbon dioxide, and, passing the compressed carbon dioxide to an oil-bearing formation. The compressed carbon dioxide is injected under pressure into the oil-bearing formation so as to produce live crude and natural gas. The compressed methane is delivered to a combustion turbine so as to produced power and an exhaust. The exhaust of the combustion turbine is passed to a steam turbine so as to produce steam and power.

### RELATED U.S. APPLICATIONS

The present application claims priority from U.S. Provisional Patent Application Ser. No. 61/293,140, filed on Jan. 7, 2010, and entitled “Ethanol Production System for Enhanced Oil Recovery”.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to the production of ethanol. More particularly, the present invention relates to the production of carbon dioxide in an ethanol process in which the carbon dioxide can be used for enhanced oil recovery. Additionally, the present invention relates to the recovery of byproducts of ethanol production for the production of power, fuel and fertilizer.

2. Description of Related Art Including Information Disclosed Under 37 CFR 1.97 and 37 CFR 1.98

Ethanol fuel is ethanol (ethyl alcohol), the same type of alcohol found alcoholic beverages. Ethanol fuel can be used as a transport fuel, mainly as a biofuel additive for gasoline. Bioethanol, unlike petroleum, is a form of renewable energy that can be produced from agricultural feedstocks. It can be made from very common crops, such as sugarcane, potato, manioc and corn. Bioethanol is usually obtained from a carbon-based feedstock. Agricultural feedstocks are considered renewable because they get energy from the sun by using photosynthesis, provided that all minerals required for growth (such as nitrogen and phosphorous) are returned to the land.

The basic steps for a large scale production of ethanol are: (1) microbial (yeast) fermentation of sugar; (2) distillation; (3) dehydration; and (4) denaturing. Ethanol is produced by microbial fermentation of the sugar. Two major components of plants, starch and cellulose, are both made up of sugars, and can, in principle, be converted to sugars for fermentation. For ethanol to be usable as a fuel, water must be removed. Most of the water is removed by distillation. A variety of distillation processes can be utilized to remove the water from the azeotropic ethanol/water mixture.

The ethanol business in the United States has evolved over the past 15 to 20 years. The ethanol business has benefited from a desire to create additional revenue for grain growers while reducing foreign oil imports, and because of the problems concerning MTBE and its use as an octane enhancer in gasoline-blendstocks. Most ethanol plants have been located in agricultural areas in states with relatively low population density and lower than average electric rates. In order to be an optimal ethanol plant, the plant must have an open access state power grid with renewable power requirements and specific set asides for renewable projects other than wind. The plant should have access to large quantities of plant feedstock through local supplies or by rail. The plant should have close proximity to a large reformulated gasoline-mandated market that requires ethanol as an octane enhancer. Such a plant should have close proximity to numerous potential enhanced oil recovery projects which do not have ready access to carbon dioxide supplies in commercial quantities. The building site should be of a reasonable cost and have a workforce capable of constructing and operating a facility.

Enhanced oil recovery can be achieved by gas injection, chemical injection, ultrasonic stimulation, microbial injection, or thermal recovery. Gas injection is presently the most commonly used approach to enhanced recovery. A gas is injected into the oil-bearing stratum under high pressure. That pressure pushes the oil into the pipe and up to the surface. In addition to the beneficial effect of the pressure, this method sometimes aids recovery by reducing the viscosity of the crude oil as the gas mixes with it. The gases commonly include carbon dioxide. Oil displacement by carbon dioxide injection relies on the phase behavior of the mixtures of that gas and the crude. These are strongly dependent upon reservoir temperature, pressure and crude oil composition. These mechanisms range from oil swelling and viscosity reduction for injection of immiscible fluids (at low pressures) to completely miscible displacement in high-pressure applications. In these applications, more than half and up to two-thirds of the injected CO₂ returns with the produced oil and is usually re-injected into the reservoir to minimize operating costs. The remainder is trapped in the oil reservoir by various means.

Carbon dioxide, under the right conditions, is miscible with many grades of crude oil. This means it can be absorbed directly into the crude and serve to loosen the grip that the crude has on the rock in the producing formation as well as serving to lighten the crude and make it less viscous. While there are other agents that can perform this function (similar to various solvents), carbon dioxide is by far the most cost-effective. With current proven technology, additional recoverable reserves equal to approximately 20% of the original oil-in place can be anticipated. This phase of production, often referred to as “tertiary production”, occurs after primary and secondary phases have been completed. There are several “rules of thumb” in determining the economics of such tertiary recovery. These rules of thumb are that 10 mcf of carbon dioxide will be injected to recover each barrel of oil. Also, 50% of the carbon dioxide injected can be recovered from the crude oil and reused. Between 4.5 to 5.5 mcf of carbon dioxide per barrel of oil produced will remain in the formation. Also, the carbon dioxide that remains in the formation is considered sequestered so as to result in carbon credits. Additionally, and furthermore, the use of such tertiary recovery processes should show results occurring between two months to two years from initiation.

The carbon tax is an environment tax on emission of carbon dioxide. Carbon dioxide is a heat-trapping “greenhouse” gas. The purpose of a carbon tax is to protect the environment while reducing emissions of carbon dioxide. The carbon tax is implemented by taxing the burning of fossil fuels—coal, petroleum products such as gasoline and aviation fuel, and natural gas—in proportion to their carbon content. If carbon dioxide emissions are not released into the atmosphere on combustion of fossil fuels, e.g. carbon capture and storage, then a carbon tax will not apply. Accordingly, the carbon tax increases the competitiveness of low-carbon technology, such as renewables, compared to the traditional burning of fossil fuels.

In the past, various patents have issued relating to ethanol production and carbon dioxide injection for enhanced oil recovery. For example, U.S. Patent Publication No. 2008/0050800 published on Feb. 28, 2008, describes an alternative energy generating apparatus for generating electricity. The apparatus includes an electric generating apparatus in which the electric generating apparatus produces flue gasses. It also has one anaerobic digester adapted to supply biogas to the electric generating apparatus. There is at least one bioreactor configured to receive a least a portion of the flue gasses from the electric generating apparatus.

U.S. Patent Publication No. 2008/0003654, published on Jan. 3, 2008 to P. J. Hirl, describes a process for the production of ethanol and energy. The process includes the steps of fermenting a corn mash in an aqueous medium to produce a beer. Next, the beer is distilled to produce ethanol and a whole stillage. The whole stillage is anaerobically digested to produce a biogas and a residue. The biogas is combusted to produce electricity and steam. The electricity and steam are used during the fermentation and distillation process. The residue may further be separated into a liquid fertilizer and top soil residue.

U.S. Pat. No. 6,355,456, issued on Mar. 12, 2002 to Hallberg et al., teaches an integrated continuous process for the production of ethanol and a biogas-containing methane. Grain is fermented in an aqueous medium to produce ethanol in the medium which contains a wet distillers' grain with solubles such as a wet grain residue and carbon dioxide. The wet grain is fed to livestock in a feedlot. The manure from the livestock is collected from beneath the floor. The collected manure is digested anaerobically with microorganisms to produce the bio-gas containing methane and a bio-fertilizer. The bio-gas is combusted to produce heat. The grain is dry-milled utilizing heat produced by the combustion.

U.S. Pat. No. 4,609,043, issued on Sep. 2, 1986 to A. F. Cullick, describes enhanced oil recovery using carbon dioxide. The carbon dioxide is injected into the oil-bearing formation under supercritical conditions so as to act as a solvent for the oil.

U.S. Pat. No. 4,299,286, issued on Nov. 10, 1981 to R. B. Alston, shows an enhanced oil recovery process employing a blend of carbon dioxide, inert gas and intermediate hydrocarbons. The carbon dioxide, the inert gas and the intermediate hydrocarbons are injected to displace petroleum downward in a conditionally miscible, gravity-stabilized displacement process. Carbon dioxide-containing blending stock is mixed with an inert gas, such as methane or nitrogen, in order to reduce its density sufficiently to increase the critical velocity of the displacement process.

U.S. Pat. No. 4,261,420, issued on Apr. 14, 1981 to D. O. Hitzman, provides a protein plant which is operated to produce high density cell growth and a substantially pure stream of generally high pressure carbon dioxide for use in enhanced oil recovery operations. The plant employs an air separator producing substantially pure streams of oxygen and nitrogen. The oxygen stream is used to enrich a carrier fluid and used for aeration of the fermenter.

U.S. Pat. No. 4,913,235, issued on Apr. 3, 1990 to Harris et al., describes enhanced oil recovery utilizing carbon dioxide flooding. The viscosity of the carbon dioxide is enhanced three-fold by adding a viscosifying amount of a polymer, a sufficient amount of cosolvent to form a one-phase solution.

U.S. Pat. No. 6,045,660, issued on Apr. 4, 2000 to Savage et al., describes an apparatus for use in the rectification of liquid mixtures and other processes requiring equilibration of liquid and gaseous phases in which mechanical energy is used to create and repeatedly regenerate free flying liquid structures that facilitate the intimate interaction and equilibration of the phases.

U.S. Pat. No. 5,830,423, issued on Nov. 3, 1998 to Trocciola et al., provides a waste gas treatment system. The gas stream is produced in and emanates from landfills, anaerobic digesters and other waste gas streams. This gas stream is used to produce a purified gas which is essentially a hydrocarbon, such as methane, and which can be used as the fuel source in a fuel cell power plant. The gas stream passes through a simplified purification system which removes essentially all of the sulfur compounds, hydrogen sulfide, and halogen compounds from the gas stream. The resultant gas stream can be used to power a fuel cell power plant which produces electricity, or as a hydrocarbon fuel gas for other applications.

U.S. Patent Publication No. 2010/0055628, published on Mar. 4, 2010 to McMurry et al., discloses a process for producing a renewable biofuel from waste water treatment plants. This fuel can be used in internal combustion engines, as a fuel source for electricity generation from turbines and fuel cells, or as a burnable heat source. The fuel is derived from set of biomolecules that are produced under nutrient limitation conditions as those found at a waste water treatment plant. This processes utilizes poly(3-hydroxyalkanoates), especially those with monomeric residues as feed stream for production of a biofuel.

U.S. Patent Publication No. 2010/0038082, published on Feb. 18, 2010 to Zubrin et al., provides a portable renewable energy source for enhanced oil recovery. A truck mobile system is utilized to reform biomass into carbon dioxide and hydrogen. The gases are then separated. The carbon dioxide is sequestered underground for enhanced oil recovery. The hydrogen is used to generate carbon-free electricity.

U.S. Patent Publication No. 2008/0017369, published on Jan. 24, 2008 to Sarada, provides a method and apparatus for generating pollution-free electrical energy from hydrocarbons. Exhaust fumes, along with other byproducts, are injected into a subterranean formation. This electrical energy can be supplied to at least one of a variety of subprocesses for producing a fuel product, such as hydrogen or ethanol. Electrical power can be generated from a non-hydrocarbon source such as thermal, solar, wind or other power source to produce electrical energy.

U.S. Patent Publication No. 2007/0249029, published on Oct. 25, 2007 to Marshall et al., teaches a self-sustaining and continuous system and method of anaerobically digesting ethanol stillage. Substantially all byproducts of this system are reintegrated into the system. The system includes an ethanol producing facility for producing ethanol and an anaerobic digestion facility for anaerobically digesting stillage from the ethanol producing facility so as to produce a plurality of byproducts. A plurality of subsystems utilize the plurality of byproducts from anaerobic digestion to produce a plurality of end products. At least one of the plurality of end-products from the various sub-systems is integrated back into the ethanol producing facility and into at least one of the sub-systems such that the system of anaerobically digesting stillage is a continuous and self-sustaining operation.

U.S. Patent Publication No. 2007/0092930, published on Apr. 26, 2007 to Lal et al., shows a process for enhanced recovery of crude oil from oil wells using a novel microbial consortium. In particular, three hyperthermophilic, barophilic, acidogenic, anaerobic bacterial strains for utilized for this enhanced oil recovery. This microbial consortium produces a variety of metabolic products, mainly, carbon dioxide, methane, biosurfactant, volatile fatty acids and alcohols in the presence of a specially designed nutrient medium. These metabolic products increase sweep efficiency of crude oil from oil-bearing poles of rock formations.

It is an object of the present invention to provide a process that maximizes the energy return from an ethanol production process.

It is an object of the present invention to provide a process which produces gas and fertilizer from the anaerobic digestion of stillage.

It is another object of the present invention to provide an ethanol process that utilizes carbon dioxide for enhanced oil recovery.

It is still a further object of the present invention to provide an ethanol process which utilizes the byproducts of the ethanol production and the anaerobic digestion of stillage so as to produce power for the process and for sales.

It is sill another object of the present invention to provide an ethanol production process that enhances the recovery of carbon credits.

It is a still further object of the present invention to provide an ethanol process that maximizes profitability and minimizes costs.

These and other objects and advantages of the present invention will become apparent from a reading of the attached specification and appended claims.

### BRIEF SUMMARY OF THE INVENTION

The present invention is an ethanol production process in which the byproducts of ethanol production enhance oil recovery and enhance power generation. Fundamentally, ethanol production is carried out in a conventional manner. Ethanol production results from the processing of corn and grain sorghum as a feedstock. As a result of the process, ethanol and waste materials (“stillage”) are produced, along with carbon dioxide. A denaturant is added to the produced ethanol so as to produce anhydrous ethanol. The denatured ethanol is then transported or pumped to a storage tank. Ultimately, the denatured ethanol in the storage tank is then passed to a truck or for rail loading and sale.

The stillage of the ethanol production process passes to an anaerobic digester. This anaerobic digester digests the stillage in the absence of oxygen so as to produce carbon dioxide, methane and a fertilizer. The carbon dioxide and methane are passed to a gas treatment facility so that the carbon dioxide and methane are purified and can be passed as separate streams. The methane can be suitably compressed for delivery to a combustion turbine. The carbon dioxide can be compressed at a compression facility for delivery to the enhanced oil recovery injection facilities.

The fertilizer that is produced from the anaerobic digestion process can be stored and/or delivered for sale.

The compressed carbon dioxide is delivered to the enhanced oil recovery injection facilities. These injection facilities deliver the carbon dioxide under pressure into the oil-bearing formations of an oilfield. The injection of the carbon dioxide from the ethanol production process enhances the ability of the oilfield to produce live crude. The live crude is then delivered to a gas/oil separation plant. Any carbon dioxide in the gas/oil separation plant is pumped for field compression and back to the enhanced oil recovery injection facilities. Any natural gas produced from the gas/oil separation plant can then be passed to a natural gas pipeline. The methane output of the anaerobic digestion process can also be delivered to the natural gas pipeline. The stabilized crude is then stored and sold.

The methane produced from the anaerobic digestion process is delivered to a combustion turbine. This combustion turbine utilizes the methane for the production of power. The power can be used for the ethanol production process or delivered as renewable power sales to the utility. The exhaust from the combustion turbine can be delivered to a heat recovery steam generator. The heat recovery steam generator produces steam from the exhaust of the combustion turbine so as to provide power to a steam turbine. The steam turbine delivers an output of steam for use by the ethanol plant or produces power for delivery to the utility.

Through the process of the present invention, it is possible to produce over 30 units of energy for every unit of energy consumed. The present invention maximizes the carbon tax credit by utilizing the carbon dioxide rather than venting the carbon dioxide to the atmosphere. A variety of products from ethanol production process result from the present invention. These products can include electric power, renewable tax credits, natural gas, carbon credits, fertilizer, crude oil, ethanol, and RIN sales.

### BRIEF DESCRIPTION OF THE SEVERAL VIEWS OF THE DRAWINGS

FIG. 1 is a block diagram showing the processing steps of the ethanol production process of the present invention.

### DETAILED DESCRIPTION OF THE INVENTION

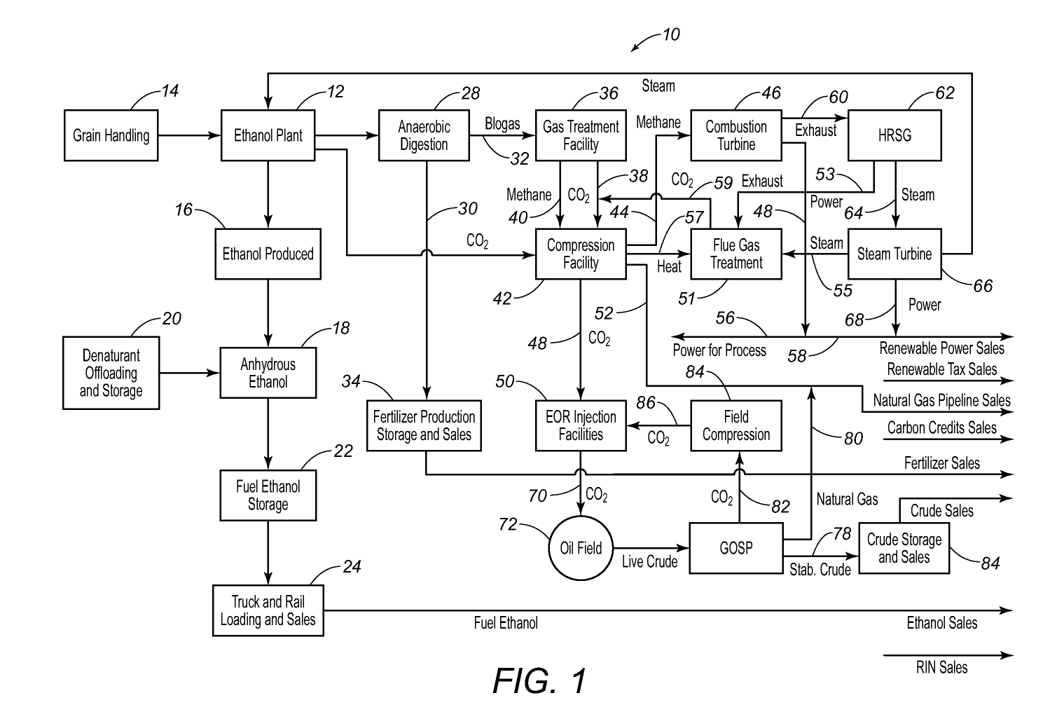

Referring to FIG. 1, there is shown the process 10 of the present invention. The process 10 of the present invention utilizes an ethanol production process so as to achieve multiple byproducts so as to enhance the energy recovery of the various components of the ethanol production process.

The initial process 10 includes an ethanol plant 12. The ethanol plant 12 is in the nature of a conventional ethanol plant 12. Initially, grain handling 14 is utilized so as to deliver the necessary feedstock to the ethanol plant. In the preferred embodiment of the present invention, the grain that is utilized is corn and grain sorghum. The ethanol plant 12 carries out the basic steps for the large scale production of ethanol. These steps are: (1) microbial (yeast) fermentation of sugar; (2) distillation; and (3) dehydration. The fermentation step utilizes the starch and cellulose components of the corn of the feedstock so as to convert the sugars therein for fermentation.

Distillation is utilized so as to remove the water from the ethanol. As such, the ethanol plant transports the produced ethanol product 16. When the water is removed from the ethanol, the ethanol becomes anhydrous ethanol 18. As can be seen in FIG. 1, a denaturant 20 is delivered with the mixing with the anhydrous ethanol. The denaturant can be methanol or other additives such as isopropyl alcohol, acetone, methyl ethyl ketone, methyl isobutyl ketone, and denatonium. During the denaturing process, the ethanol molecule is not chemically altered. The only thing that is affected is the ingestability of the ethanol. The denatured ethanol is then transported to a storage tank 22. Ultimately, the fuel ethanol from the storage tank 22 is delivered for truck and rail loading and sales 24. As a result, the ethanol product of the ethanol plant 12 can be sold as a biofuel.

The stillage 26 of the ethanol plant 12 is delivered to an anaerobic digester 28. The anaerobic digestion is a series of processes in which microorganisms break down biodegradable material in the absence of oxygen. The anaerobic digestion reduces the emission of landfill gas into the atmosphere. Anaerobic digestion is often used as a renewable energy resource because the process produces a methane and carbon dioxide-rich biogas suitable for energy production. This helps to replace fossil fuels. Also, the nutrient-rich digestate 30 can be used as a fertilizer. The digestion process begins with bacterial hydrolysis of the input materials 26 in order to break down insoluble organic polymers, such as carbohydrates, and make them available for other bacteria. Acidogenic bacteria then converts the sugars and amino acids into carbon dioxide, hydrogen, ammonia, and organic acids. Acetogenic bacteria then converts these resulting organic acids into acetic acids, along with additional ammonia, hydrogen and carbon dioxide. Methanogens are finally able to convert these products into methane and carbon dioxide. As such, the methane and carbon dioxide 32 can be passed from the anaerobic digester 28 as a product of the process.

The fertilizer that is passed from the anaerobic digester 28 is delivered for storage and sales 34. As such, the fertilizer can be sold as a product of the process 10.

The carbon dioxide and methane products of the anaerobic digester 28 are delivered to a gas treatment facility 36 so as to separate the carbon dioxide 38 and the methane 40. The carbon dioxide 38 is delivered as a separate flow from the methane 40 to a compression facility 42. The compressed methane 44 is passed from the compression facility 42 to a combustion turbine 46. The compressed carbon dioxide 48 is passed from the compression facility 42 to the enhanced oil recover injection facility 50. Additionally, the compressed methane 52 can be delivered to a natural gas pipeline. As such, this methane can be sold as an additional product of the process 10.

The compressed methane 44 is delivered to the combustion turbine 46. The combustion turbine 46 will burn the compressed methane 44 so as to produce electrical energy 48. The electrical energy 48 can be delivered as power 50 for the process 10, or as power 58 to the utility. As such, the electrical energy can be considered a sellable product of the process 10. The exhaust 60 of the combustion turbine 46 is delivered to a heat recovery steam generator 62. The heat recovery steam generator 62 is an energy recovery heat exchanger that recovers heat from a hot gas stream. The heat recovery steam generator 62 produces steam 64 that can be used in a process or used to drive steam turbine 66. The ability to drive the steam turbine by the heat recovery steam generator produces electricity more efficiently than either the gas turbine 46 or the steam turbine 66 alone. Ultimately, the steam turbine 66 produces a power output 68. The power output 68 can be delivered to the utility as a sellable product or reused as part of the power of the process 10.

As can be seen in FIG. 1, the flue gas is treated at flue gas treatment facility 51. The flue gas treatment facility 51 will receive the exhaust from the heat recovery steam generator 62. The flue gas treatment will receive the exhaust 53 from the heat recovery steam generator 62. The flue gas treatment facility 51 will receive steam 55 from the steam turbine 66. Additionally and furthermore, the compression facility 42 will supply heat 57 for use by the flue gas treatment facility 51. A carbon dioxide product 59 of the flue gas treatment facility 51 is delivered along line 38 back to the compression facility 42. In accordance with a heat balance formula, the compression facility 42 will generate approximately 50% of the heat required to regenerate the amine that is used to capture the carbon dioxide from the flue gas. Prior to the present invention, this heat would be simply discharged to the atmosphere by using fan-driven coolers and heat that was taken back from the back-pressure turbine 66 or the heat recovery steam generator 62. As such, the use of the flue gas treatment facility 51, along with the heat supplied from the compression facility 42, adds an enhanced level of efficiency to the process of the present invention.

The compressed carbon dioxide 48 that is delivered to the enhanced oil recovery injection facility 50 can be delivered as compressed carbon dioxide 70 to the oilfield 72. The carbon dioxide is injected into the oil-bearing stratum under high pressure. This pressure pushes oil into the pipe and up to the surface as live crude 74. The carbon dioxide also aids recovery by reducing the viscosity of the crude oil as the gas mixes with it. The live crude 74 is delivered to a gas/oil separation plant 76. This gas/oil separation plant will serve to separate the stabilized crude 78 from natural gas 80 and from the carbon dioxide 82. The stabilized crude 78 can be delivered to a storage tank 84. Ultimately, the stabilized crude 78 can be sold as a product of the process 10. The natural gas 80 can be delivered to the natural gas pipeline 52 as another sellable product of the process 10. Finally, the carbon dioxide from the gas/oil separation plant 76 can be delivered for field compression 84. As such, the compressed carbon dioxide 86 is redelivered to the enhanced oil recover injection facility 50 for reuse in the oilfield. As a result of this process, carbon dioxide is not released into the atmosphere but is properly reused so as to maximize carbon credit sales as a product of the process.

The present invention achieve enormous benefits over prior ethanol plants. As shown in Table I hereinbelow:

TABLE I

| | Btu/Bushel | Btu/Gallon |
|---|---|---|
| Energy of Farm Inputs | 55,164 | 19,701 |
| Energy for Corn Transportation | 3,150 | 1,125 |
| Energy for Ethanol Conversion | 149,176 | 53,277 |
| Energy for Ethanol Distribution | 2,501 | 893 |
| Energy Credits for Coproducts | (54,012) | (19,290) |
| Total Energy Consumed per Gallon | 155,979 | 55,707 |
| Ethanol Energy Produced | | 84,100 |
| Energy Ratio | | 1.51 |

As can be seen in Table 1, the energy ratio for the typical ethanol plant is 1.51. This represents units of energy produced over energy consumed. As can be seen, the typical plant only has a marginal advantage of energy produced over energy consumed. In contrast, Table II shows the enormous benefits achieved by the process 10 of the present invention. Table II represents the energy recover at a plant that does not include the steps associated with enhanced oil recovery.

TABLE II

| | Btu/Bushel | Btu/Gallon |
|---|---|---|
| Energy of Farm Inputs | 55,164 | 19,701 |
| Energy for Corn Transportation | 6,000 | 2,143 |
| Energy for Ethanol Conversion | — | — |
| Energy for Ethanol Distribution | 1,500 | 536 |
| Energy Credits for Coproducts | (54,886) | (19,602) |
| Total Energy Consumed per Gallon | 7,778 | 2,778 |
| Ethanol Energy Produced | | 84,100 |
| Energy Ratio | | 30.28 |

As can be seen, the energy ratio for a plant without enhanced energy recover is 30.28 units of energy produced for every one unit of energy consumed. These benefits are enormously enhanced when enhanced oil recover is considered as part of the process. Table III hereinbelow represents the process 10 of the present invention as used in association with enhanced oil recovery.

TABLE III

| | Btu/Bushel | | Btu/Gallon |
|---|---|---|---|
| Total Energy Consumed per Gallon | 7,778 | 2.8 | 2,778 |
| Total Energy Produced per Gallon | | | |
| Ethanol Energy Produced | 84,100 | 1.0 | 84,100 |
| Energy of Crude Oil Barrel | 105,047 | 1.0 | 105,047 |
| Energy Consumed to Produce Barrel | (15,757) | 1.0 | (15,757) |
| Total Energy Produced per Gallon | 173,390 | | 173,390 |
| Energy Ratio | | | 62.42 |

As can be seen, the energy ratio is 62.42 units of the energy produced for every unit of energy consumed. Quite clearly, the ability to achieve enhanced oil recovery from carbon dioxide injection enormously enhances the benefits associated with the ethanol process 10 of the present invention.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A process for enhancing energy output of an ethanol production facility, the method comprising:
producing ethanol and stillage from a feedstock;
anaerobically digesting said stillage so as to produce carbon dioxide and methane;
compressing the methane;
compressing the carbon dioxide; and
passing the compressed carbon dioxide to an oil-bearing formation.

2. The process of claim 1, further comprising:
delivering the compressed methane to a combustion turbine so as to produce power and an exhaust.

3. The process of claim 2, further comprising:
passing the exhaust of the combustion turbine to a steam turbine so as to produce steam and power.

4. The process of claim 3, further comprising:
treating a flue gas of the exhaust of said combustion turbine with the steam from said steam turbine so as to produce carbon dioxide.

5. The process of claim 4, the step of treating the flue gas comprising:
delivering heat from the steps of compressing the methane and the carbon dioxide to the treating of the flue gas.

6. The process of claim 1, the step of anaerobically digesting further comprising:
producing a fertilizer from the stillage.

7. The process of claim 1, the step of passing the carbon dioxide to an oil-bearing formation comprising:
injecting the compressed carbon dioxide under pressure into the oil-bearing formation; and
producing live crude and natural gas from the oil-bearing formation.

8. The process of claim 7, further comprising:
passing the natural gas from the oil-bearing formation to a pipeline; and
passing a portion of the compressed methane to the pipeline.

9. The process of claim 1, the step of producing ethanol and stillage comprising:
adding a denaturant to the ethanol so as to produce anhydrous ethanol; and
storing the anhydrous ethanol.

10. The process of claim 4, the step of producing ethanol further comprising:
receiving steam from the combustion turbine.

11. The process of claim 1, the step of producing ethanol and stillage producing a carbon dioxide byproduct, the process further comprising:
delivering the carbon dioxide byproduct to a compressor; and
compressing the delivered carbon dioxide byproduct.

12. A process for enhancing energy output of an ethanol production facility, the method comprising:
producing carbon dioxide from the ethanol production facility;
compressing the produced carbon dioxide; and
passing the compressed carbon dioxide into an oil-bearing formation.

13. The process of claim 12, the step of passing the compressed carbon dioxide comprising:
injecting the compressed carbon dioxide under pressure into the oil-bearing formation; and
producing live crude and natural gas from the oil-bearing formation.

14. The process of claim 12, the step of producing carbon dioxide comprising:
anaerobically digesting stillage from the ethanol production facility so as to produce the carbon dioxide and methane.

15. The process of claim 14, further comprising:
compressing the methane; and
delivering the compressed methane to a combustion turbine so as to produce power and an exhaust.

16. The process of claim 15, further comprising:
passing the exhaust of the combustion turbine to a steam turbine so as to produce steam and power.

17. The process of claim 16, further comprising:
treating a flue gas of the exhaust of this combustion turbine with the steam from said steam turbine so as to produce carbon dioxide.

18. The process of claim 17, the step of treating the flue gas comprising:
delivering heat from the steps of compressing the methane and the carbon dioxide to the treating of the flue gas.

19. The process of claim 12, further comprising:
passing the natural gas from the oil-bearing formation to a pipeline; and
passing a portion of the compressed methane to the pipeline.

20. A process for enhancing energy output of an ethanol production facility, the process comprising:
producing ethanol and stillage from a feedstock;
anaerobically digesting said stillage so as to produce carbon dioxide and methane;
compressing the methane and the carbon dioxide;
delivering the compressed methane to a combustion turbine so as to produce power and an exhaust; and
passing the exhaust of the combustion turbine to a steam turbine so as to produce steam and power.
